(19) United States
(12) Patent Application Publication
(10) Pub. No.: US 2015/0287494 A1
(43) Pub. Date: Oct. 8, 2015

(54) NITROGEN-CONTAINING COMPOUNDS AS ADDITIVES FOR TRANSPARENT CONDUCTIVE FILMS

(71) Applicant: Carestream Health, Inc., Rochester, NY (US)

(72) Inventors: James B. Philip, JR., Fort Meyers, FL (US); Doreen C. Lynch, Afton, MN (US); Chaofeng Zou, Maplewood, MN (US); William D. Ramsden, Afton, MN (US); Haiyun Lu, Woodbury, MN (US)

(21) Appl. No.: 14/625,779

(22) Filed: Feb. 19, 2015

Related U.S. Application Data
(60) Provisional application No. 61/976,542, filed on Apr. 8, 2014.

(51) Int. Cl. H01B 1/22; H01B 13/00

(52) U.S. Cl. CPC H01B 1/22; H01B 13/0026

(57) ABSTRACT

A transparent conductive article comprising a transparent support and at least one first layer disposed on the transparent support, the at least one first layer comprising a network of silver nanowires dispersed within at least one polymer binder, where the transparent conductive article comprises one or more additives, the one or more additives comprising at least one amine compound.

### CROSS-REFERENCE TO RELATED APPLICATIONS

This application claims the benefit of U.S. Provisional Application No. 61/976,542, filed Apr. 8, 2014, entitled “NITROGEN-CONTAINING COMPOUNDS AS ADDITIVES FOR TRANSPARENT CONDUCTIVE FILMS,” which is hereby incorporated by reference in its entirety.

### BACKGROUND

Transparent conductive films (TCF) have been used extensively in recent years in applications, such as touch panel displays, liquid crystal displays, electroluminescent lighting, organic light-emitting diode devices, and photovoltaic solar cells. Indium tin oxide (ITO) based transparent conductive film has been the transparent conductor-of-choice for most applications due to its high conductivity, transparency, and relatively good stability. However, indium tin oxide based transparent conductive films have limitations due to the high cost of indium, the need for complicated and expensive vacuum deposition equipment and processes, and indium tin oxide's inherent brittleness and tendency to crack, especially when it is deposited on flexible substrates.

Some important parameters for measuring the properties of transparent conductive films are total light transmittance (% T), haze (H), and film surface electrical conductivity. Higher light transmittance allows clear picture quality for display applications and higher efficiency for lighting and solar energy conversion applications. Lower resistivity is most desirable for most transparent conductive film applications in which power consumption can be minimized. Therefore, the higher the T/R ratio of the transparent conductive films is, the better the transparent conductive films are.

U.S. Patent Application Publication 2006/0257638A1 discloses a transparent conductive film comprising carbon nanotubes (CNT) and vinyl chloride resin polymer binder.

U.S. Pat. No. 8,049,333 and U.S. Patent Application Publication 2008/0286447A1 disclose a transparent conductive film in which silver nanowires are deposited onto a substrate to form a bare nanowire network followed by overcoating the silver nanowire network with a polymer matrix material to form a transparent conductive film. The polymer materials such as polyacrylates and carboxyl alkyl cellulose ether polymers were suggested as useful materials for the matrix.

U.S. Patent Application Publication 2008/0286447A1 discloses the use of aromatic triazoles and other nitrogen containing compounds as corrosion inhibitors for silver nanowire based transparent conductors. Long chain alkylthio compounds have also been disclosed as useful corrosion inhibitors.

U.S. Patent Application Publication 2008/0292979A1 discloses a transparent conductive film comprising silver nanowires, or a mixture of silver nanowires and carbon nanotubes. The transparent conductive network is formed either without polymer binder or in a photoimageable composition. The transparent and conductive films were coated on both glass and polyethylene terephthalate (PET) supports.

U.S. Pat. No. 8,052,773 discloses a transparent conductive film which is formed from coating of silver nanowires to form a network followed by overcoating with a layer of urethane acrylate polymer.

U.S. Patent Application Publication 2011/0024159A1 discloses use of corrosion inhibitors in an overcoat layer of a transparent conductive film.

PCT Patent Publication WO 2011/115603A1 discloses anticorrosion agents comprising 1,2-diazine compounds for use in transparent conductive films.

U.S. Patent Application Publication 2010/0307792A1 discloses addition of coordination ligands with silver nanowire aqueous dispersion to form sediments followed by separation of such sediments from the supernatant containing halide ions before apply such silver nanowire dispersion in the coating and formation of the transparent conductive film.

EP Patent Application Publication EP2251389A1 discloses a silver nanowire (AgNW) based ink formulation in which various aqueous silver complex ions were added into silver nanowire based ink in a ratio of complex ion to AgNW of no more than 1:64 (w:w).

U.S. Patent Application Publication 2013/0001478 discloses various corrosion inhibitors.

### SUMMARY OF THE INVENTION

In some embodiments, a transparent conductive article comprises a transparent support and at least one first layer disposed on the transparent support, the at least one first layer comprising a network of silver nanowires dispersed within at least one polymer binder, where the transparent conductive article comprises one or more additives, the one or more additives comprising at least one amine compound. In some embodiments, the at least one first layer comprises the one or more additives, the one or more additives comprising at least one amine compound. In some embodiments, the transparent conductive article may comprise at least one second layer, wherein the at least one second layer comprises the one or more additives, the one or more additives comprising at least one amine compound. In some embodiments, the at least one second layer is disposed on the at least one first layer.

In some embodiments, the at least one amine compound comprises at least one primary amine. In some embodiments, the at least one amine compound comprises at least one secondary amine. In some embodiments, the at least one amine compound comprises at least one tertiary amine. In some embodiments, the one or more additives comprising at least one amine compound comprises a mixed amine, the mixed amine comprising a first amine and a second amine selected from the classification group consisting of a primary amine, a secondary amine, and a tertiary amine, the classification group of the first amine being different from the classification group of the second amine.

In some embodiments, the at least one amine compound comprises tert-butylamine. In some embodiments, the at least one amine compound comprises benzylamine. In some embodiments, the at least one amine compound comprises piperidine. In some embodiments, the at least one amine compound comprises morpholine. In some embodiments, the at least one amine compound comprises triethylamine. In some embodiments, the at least one amine compound comprises N,N-diisopropylethylamine. In some embodiments, the at least one amine compound comprises N-methyldiethanolamine. In some embodiments, the at least one amine compound comprises 4-(2-hydroxylethyl)morpholine. In some embodiments, the at least one amine compound comprises 4-methylmorpholine. In some embodiments, the at least one amine compound comprises 1-(2-aminoethyl)-piperazine. In some embodiments, the at least one amine compound comprises N,N-diethylethylenediamine.

In some embodiments, a transparent conductive article comprises a transparent support and at least one first layer disposed on the transparent support, the at least one first layer comprising a network of silver nanowires dispersed within at least one polymer binder, where the transparent conductive article comprises one or more additives, the one or more additives comprising at least one nitrogen heterocyclic compound selected from the group consisting of 1-decyl-2-methyl-imidazole, pyridine-containing compound, and pyrimidine-containing compound.

In some embodiments, the at least one first layer comprises the one or more additives, the one or more additives comprising at least one nitrogen heterocyclic compound selected from the group consisting of 1-decyl-2-methyl-imidazole, pyridine-containing compound, and pyrimidine-containing compound. In some embodiments, the transparent conductive article comprises at least one second layer, where the at least one second layer comprises the one or more additives, the one or more additives comprising at least one nitrogen heterocyclic compound selected from the group consisting of 1-decyl-2-methyl-imidazole, pyridine-containing compound, and pyrimidine-containing compound.

In some embodiments, the at least pyridine-containing compound comprises pyridine. In some embodiments, the at least pyridine-containing compound comprises 4-picoline. In some embodiments, the at least pyridine-containing compound comprises 2-picoline. In some embodiments, the at least pyridine-containing compound comprises 2,6-lutidine. In some embodiments, the at least pyrimidine-containing compound comprises 4-methylpyrimidine.

In some embodiments, the silver nanowires are present in an amount sufficient to provide a surface resistivity of less than 1000 ohm/sq. In some embodiments, the silver nanowires have an aspect ratio of from about 20 to about 3300. In some embodiments, the silver nanowires are present in an amount of from about 10 mg/m² to about 500 mg/m². In some embodiments, the transparent conductive article has a transmittance of at least 80% across entire spectrum range of from about 350 nm to about 1100 nm and a surface resistivity of 500 ohm/sq or less.

In some embodiments, the at least one polymer binder comprises at least one water soluble polymer. In some embodiments, the at least one water soluble polymer comprises gelatin, polyvinyl alcohol, or mixtures thereof. In some embodiments, the at least one polymer binder further comprises up to 50 wt % of one or more additional water soluble polymers. In some embodiments, one or more of the additional water soluble polymers is a polyacrylic polymer. In some embodiments, the at least one polymer binder comprises at least one organic solvent soluble polymer. In some embodiments, the at least one organic solvent soluble polymer binder comprises at least one cellulose ester polymer. In some embodiments, the at least one organic solvent soluble polymer binder comprises cellulose acetate, cellulose acetate butyrate, or cellulose acetate propionate, or mixtures thereof. In some embodiments, the at least one cellulose ester polymer has a glass transition temperature of at least 100° C. In some embodiments, the at least one polymer binder further comprises up to 50 wt % of one or more additional organic solvent soluble polymers. In some embodiments, the one or more of the additional organic solvent soluble polymers is a polyester polymer. In some embodiments, the at least one second layer is disposed on the at least one first layer.

In some embodiments, a method of forming a transparent conductive article comprises applying at least one first coating mixture onto a transparent support to form at least one first coated layer, the at least one first coating mixture comprising silver nanowires and at least one polymer binder, where the transparent conductive article comprises one or more additives, the one or more additives comprising at least one amine group or at least one nitrogen heterocyclic compound selected from the group consisting of 1-decyl-2-methyl-imidazole, pyridine-containing compound, and pyrimidine-containing compound. In some embodiments, the method comprises applying at least one second coating mixture to form at least one second coated layer, wherein the applying the at least one first coating mixture and the applying the at least one second coating mixture occur simultaneously. In some embodiments, the method comprises applying at least one second coating mixture to form at least one second coated layer and drying the at least one first layer or the at least one second layer or both.

In some embodiments, the at least one first layer comprises the one or more additives, the one or more additives comprising at least one nitrogen heterocyclic compound selected from the group consisting of 1-decyl-2-methyl-imidazole, pyridine-containing compound, and pyrimidine-containing compound. In some embodiments, the at least one second layer comprises the one or more additives, the one or more additives comprising at least one nitrogen heterocyclic compound selected from the group consisting of 1-decyl-2-methyl-imidazole, pyridine-containing compound, and pyrimidine-containing compound. In some embodiments, the at least one second coated layer is disposed onto the at least one first coated layer.

In some embodiments, a method comprises comparing a first multiplicative product of surface resistivity and haze for a first transparent conductive article having a first surface resistivity and a first haze made from a first coating solution at a first solution age using a first drying temperature with a second multiplicative product of surface resistivity and haze for a second transparent conductive article having a second surface resistivity and a second haze made from a second coating solution at a second solution age using a second drying temperature.

In some embodiments, the first coating solution comprises a first additive and the second coating solution comprises a second additive, the first additive and the second additive being different. In some embodiments, the first coating solution comprises a first nitrogen containing compound and the second coating solution comprises a second nitrogen containing compound, the first nitrogen containing compound and the second nitrogen containing compound being different. In some embodiments, the first coating solution has no nitrogen containing compound and the second coating solution comprises a nitrogen containing compound. In some embodiments, the method comprises calculating the difference between the first multiplicative product and the second multiplicative product, where the first coating solution has no nitrogen containing compound and the second coating solution comprises a nitrogen containing compound, where the first solution age and the second solution age are the same, and where the first drying temperature and the second drying temperature are the same.

### DESCRIPTION

All publications, patents, and patent documents referred to in this document are incorporated by reference in their entirety, as though individually incorporated by reference.

U.S. Provisional Application No. 61/976,542 filed Apr. 8, 2014, entitled “NITROGEN-CONTAINING COMPOUNDS AS ADDITIVES FOR TRANSPARENT CONDUCTIVE FILMS,” is hereby incorporated by reference in its entirety.

### DEFINITIONS

The terms “conductive layer” or “conductive film” refer to the network layer comprising silver nanowires dispersed within a polymer binder.

The term “conductive” refers to electrical conductivity.

The term “article” refers to the coating of a “conductive layer” or “conductive film” on a support.

The terms “coating weight,” “coat weight,” and “coverage” are synonymous, and are usually expressed in weight or moles per unit area such as g/m² or mol/m².

The term “transparent” means capable of transmitting visible light without appreciable scattering or absorption.

The term “haze” is wide-angle scattering that diffuses light uniformly in all directions. It is the percentage of transmitted light that deviates from the incident beam by more than 2.5 degrees on the average. Haze reduces contrast and results in a milky or cloudy appearance. Materials having lower haze percentages appear less hazy than those having higher haze percentages.

The term “organic solvent” means “a material, liquid at use temperature, whose chemical formula comprises one or more carbon atoms.”

The term “aqueous solvent” means a material, liquid at use temperature, whose composition in a homogeneous solution comprises water in the greatest proportion (i.e., at least 50 per cent water by weight).

The term “water soluble” means the solute forms a homogenous solution with water, or a solvent mixture in which water is the major component.

The terms “a” or “an” refer to “at least one” of that component (for example, the anticorrosion agents, nanowires, and polymers described herein).

Furthermore, all publications, patents, and patent documents referred to in this document are incorporated by reference herein in their entirety, as though individually incorporated by reference.

### INTRODUCTION

In some applications, it may be desirable for silver based transparent conductors to have maximized electrical conductivity and minimized haze. We have discovered that incorporation of nitrogen containing compounds into a transparent conductive film may lead to improved electrical conductivity, haze, or a combination thereof, for the transparent conductive film.

A transparent conductive film may comprise a transparent support and at least one first layer disposed on the transparent support. The at least one first layer may comprise a network of silver nanowires dispersed within at least one polymer binder. In some cases, at least one second layer is disposed on the at least one first layer. Nitrogen containing compounds may be incorporated into any layer of the transparent conductive film, for example, the transparent support, at least one first layer, and/or at least one second layer.

### Silver Nanowires

The silver nanowires are an essential component for imparting electrical conductivity to the conductive films, and to the articles prepared using the conductive films. The electrical conductivity of the silver nanowire based transparent conductive film is mainly controlled by a) the conductivity of a single nanowire, b) the number of nanowires between the terminals, and c) the number of connections and the contact resistivity between the nanowires. Below a certain nanowire concentration (also referred as the percolation threshold), the conductivity between the terminals is zero, as there is no continuous current path provided because the nanowires are spaced too far apart. Above this concentration, there is at least one current path available. As more current paths are provided, the overall resistance of the layer will decrease. However, as more current paths are provided, the clarity (i.e., percent light transmission) of the conductive film decreases due to light absorption and back scattering by the nanowires. Also, as the amount of silver nanowires in the conductive film increases, the haze of the transparent film increases due to light scattering by the silver nanowires. Similar effects will occur in transparent articles prepared using the conductive films.

In one embodiment, the silver nanowires have aspect ratio (length/width) of from about 20 to about 3300. In another embodiment, the silver nanowires have an aspect ratio (length/width) of from about 500 to 1000. Silver nanowires having a length of from about 5 μm to about 100 μm (micrometer) and a width of from about 10 nm to about 200 nm are useful. Silver nanowires having a width of from about 20 nm to about 100 nm and a length of from about 10 μm to about 50 μm are also particularly useful for construction of a transparent conductive film.

Silver nanowires can be prepared by known methods in the art. In particular, silver nanowires can be synthesized through solution-phase reduction of a silver salt (e.g., silver nitrate) in the presence of a polyol (e.g., ethylene glycol or propylene glycol) and poly(vinyl pyrrolidone). Large-scale production of silver nanowires of uniform size can be prepared according to the methods described in, e.g., Ducamp-Sanguesa, C. et al, J. of Solid State Chemistry, (1992), 100, 272-280; Xia, Y. et al., Chem. Mater (2002), 14, 4736-4745, Xia, Y. et al., Nano Letters, (2003), 3(7), 955-960; U.S. Patent Application Publication 2012/0063948, published Mar. 15, 2012; U.S. Patent Application Publication 2012/0126181, published May 24, 2012; U.S. Patent Application Publication 2012/0148436, published Jun. 14, 2012; U.S. Pat. No. 8,551,211, issued Sep. 18, 2013; and U.S. Patent Publication 2012/0328469, published Dec. 27, 2012, each of which is incorporated by reference in its entirety.

### Polymer Binders

For a practical manufacturing process for transparent conductive films, it is important to have both the conductive components, such as silver nanowires, and a polymer binder in a coating solution. The polymer binder solution serves a dual role, as dispersant to facilitate the dispersion of silver nanowires and as a viscosifier to stabilize the silver nanowire coating dispersion so that the sedimentation of silver nanowires does not occur at any point during the coating process. It is also desirable to have the silver nanowires and the polymer binder in a single coating dispersion. This simplifies the coating process and allows for a one-pass coating, and avoids the method of first coating bare silver nanowires to form a weak and fragile film that is subsequently over-coated with a polymer to form the transparent conductive film.

In order for a transparent conductive film to be useful in various device applications, it is also important for the polymer binder of the transparent conductive film to be optically transparent and flexible, yet have high mechanical strength, good hardness, high thermal stability, and light stability. This requires polymer binders to be used for transparent conductive film to have Tg (glass transition temperature) greater than the use temperature of the transparent conductive film.

Transparent, optically clear polymer binders are known in the art. Examples of suitable polymeric binders include, but are not limited to: polyacrylics such as polymethacrylates (e.g., poly(methyl methacrylate)), polyacrylates and polyacrylonitriles, polyvinyl alcohols, polyesters (e.g., polyethylene terephthalate (PET), polybutylene terephthalate, and polyethylene naphthalate), polymers with a high degree of aromaticity such as phenolics or cresol-formaldehyde (NOVOLACS®), polystyrenes, polyvinyltoluene, polyvinylxylene, polyimides, polyamides, polyamideimides, polyetheramides, polysulfides, polysulfones, polyphenylenes, and polyphenyl ethers, polyurethanes (PU), polycarbonates, epoxies, polyolefins (e.g. polypropylene, polymethylpentene, and cyclic olefins), acrylonitrile-butadiene-styrene copolymer (ABS), cellulosics, silicones and other silicon-containing polymers (e.g. polysilsesquioxanes and polysilanes), polyvinylchloride (PVC), polyvinylacetates, polynorbornenes, synthetic rubbers (e.g. EPR, SBR, EPDM), and fluoropolymers (e.g., polyvinylidene fluoride, polytetrafluoroethylene (TFE) or polyhexafluoropropylene), copolymers of fluoro-olefin and hydrocarbon olefin (e.g., LUMIFLON®), and amorphous fluorocarbon polymers or copolymers (e.g., CYTOP® by Asahi Glass Co., or TEFLON® AF by Du Pont), polyvinylbutryals, polyvinylacetals, gelatins, polysaccharides, and starches.

In certain embodiments, in order to disperse and stabilize silver nanowires in polymeric coating solution, the use of polymer binders having high oxygen content is advantageous. Oxygen-containing groups, such as hydroxyl group and carboxylate groups have a strong affinity for binding to the silver nanowire surface and facilitate the dispersion and stabilization. Many oxygen-rich polymers also have good solubility in the polar organic solvents commonly used to prepare organic solvent-coated materials, while other oxygen-rich polymers have good solubility in water or the aqueous solvent mixtures commonly used to prepare aqueous solvent-coated materials.

In certain embodiments, cellulose ester polymers, such as cellulose acetate butyrate (CAB), cellulose acetate (CA), or cellulose acetate propionate (CAP) are superior to other oxygen-rich polymer binders when used to prepare silver nanowire based transparent conductive films that are coated from organic solvents such as 2-butanone (methyl ethyl ketone, MEK), methyl iso-butyl ketone, acetone, methanol, ethanol, 2-propanol, ethyl acetate, propyl acetate, butyl acetate, or mixtures thereof. Their use results in transparent conductive films in which both the optical light transmittance and electrical conductivity of the coated films are greatly improved. In addition, these cellulose ester polymers have glass transition temperatures of at least 100° C. and provide transparent, flexible films having high mechanical strength, good hardness, high thermal stability, and light stability.

The cellulose ester polymers can be present in from about 40 to about 90 wt % of the dried transparent conductive films. Preferably, they are present in from about 60 to about 85 wt % of the dried films. In some constructions, a mixture of a cellulosic ester polymer and one or more additional polymers may be used. These polymers should be compatible with the cellulosic polymer. By compatible, it is meant that a mixture comprising at least one cellulosic ester polymer and one or more additional polymers form a transparent, single phase composition when dried. The additional polymer or polymers can provide further benefits such as promoting adhesion to the support and improving hardness and scratch resistance. As above, total wt % of all polymers is from about 40 to about 95 wt % of the dried transparent conductive films. Preferably, the total weight of all polymers is from about 60 to about 85 wt % of the dried films. Polyester polymers, urethanes, and polyacrylics are examples of additional polymers useful for blending with cellulosic ester polymers.

In other embodiments, water soluble polymer binders can also be used, such as polyvinyl alcohol, gelatin, polyacrylic acid, polyimides. Other water dispersible latex polymers can also be used such as polyacrylates and polymethacrylates containing methyl acrylic acid units. Coating from aqueous solutions can benefit the environment and reduce the emission of volatile organic compounds during manufacturing.

The use of water soluble polymers, such as polyvinyl alcohol or gelatin as binders for silver nanowire based transparent conductors results in superior transparent conductive films in which both film transmittance and conductivity are greatly improved. Transparent conductive films prepared using either polyvinyl alcohol or gelatin polymer binders also show excellent clarity, scratch resistance, and hardness when polymer cross linkers are added to the polymer solution. Transparent conductive films prepared according methods disclosed in this application provide transmittance of at least 80% across entire spectrum range of about 350 nm to about 1100 nm, and surface resistivity of 500 ohm/sq or less.

The transparent conductive articles comprising silver nanowires and water soluble polymer binders also show excellent clarity, high scratch resistance, and hardness. In addition, transparent conductive films prepared using these polymer binders have good adhesion to supports comprising polyethylene terephthalate (PET), poly(methylmethacrylate), polycarbonate, and the like, when an appropriate subbing layer is applied between the support and the conductive layer.

The water soluble polymer binders are present in from about 40 to about 95 wt % of the dried transparent conductive films. Preferably, they are present in from about 60 to about 85 wt % of the dried films.

In some constructions, up to 50 wt % of the gelatin or polyvinyl alcohol polymer binder can be replaced by one or more additional polymers. These polymers should be compatible with the gelatin or polyvinyl alcohol polymer binder. By compatible, it is meant that the all polymers form a transparent, single phase mixture when dried. The additional polymer or polymers can provide further benefits such as promoting adhesion to the support and improving hardness and scratch resistance. Water soluble acrylic polymers are particularly preferred as additional polymers. Examples of such polymers are polyacrylic acid and polyacrylamides, and copolymers thereof. As above, total wt % of all polymers is from about 50 to about 95 wt % of the dried transparent conductive films. Preferably, the total weight of all polymers is from about 70 to about 85 wt % of the dried films.

If desired, scratch resistance and hardness of the transparent conductive films with these polymer binders to the support can be improved by use of crosslinking agents to crosslink the polymer binders. Isocyanates, alkoxyl silanes, and melamines are examples of typical crosslinking agents for cellulose ester polymers containing free hydroxyl groups. Vinyl sulfones and aldehydes are examples of typical crosslinking agents for gelatin binders.

It is also noted that examples of polymers suitable as a binder for silver nanowires as discussed above may also be suitable as a material for forming additional layers that may or may not comprise silver nanowires, such as the at least one second layer (e.g. top coat layer). For example, it was mentioned above that cellulose acetate butyrate may be suitable as a polymer binder. Cellulose acetate butyrate may be a suitable polymer for the at least one second layer.

### Electrical Conductivity and Haze

Additives are chemical compounds (e.g. nitrogen-containing compounds) that, when added to the transparent conductive film, may improve the transparent conductive film. One such improvement of the transparent conductive film may be improved electrical conductivity, haze, or a combination thereof. Improved electrical conductivity may be characterized by an increased electrical conductivity value. Improved haze may be characterized by a lower haze value. Where a transparent conductive film might have a first electrical conductivity and a first haze, the incorporation of an additive into making the transparent conductive film may yield a transparent conductive film having a second electrical conductivity and a second haze. In some cases, the second electrical conductivity may be higher than the first electrical conductivity, and the first haze and the second haze may be substantially similar. In some cases, the second haze may be lower than the first haze, and the first electrical conductivity and the second electrical conductivity may be substantially similar. In this application, when a first property is “substantially similar” to a second property, the first property is within a 10% difference of the second property. In some cases, the difference may be within 5%, within 1%, etc.

The improvement in electrical conductivity, haze, or a combination thereof, from inclusion of the additive relative to exclusion of the additive from the transparent conductive film may be determined by R×H, which is the product of the surface resistivity and % haze:

R×H=(Surface resistivity)×(Percent Haze)

Surface resistivity quantifies how strongly a given thin film opposes the flow of electric current. A low resistivity indicates a material that readily allows the movement of electric charge. Surface resistivity may be measured in units of ohms/sq.

Percent Haze, which is denoted as H, is the percentage of transmitted light that deviates from the incident beam by more than 2.5 degrees on the average. Haze reduces contrast and results in a milky or cloudy appearance.

Additives yielding lower R×H values may be indicative of their ability to provide a transparent conductive film with an improved combination of electrical conductivity and haze.

Additional benefits of additives (e.g. nitrogen-containing compounds) may include, for example, improving coating solution stability and stabilizing the transparent conductive film from, such as, atmospheric corrosion.

### Coating Solution Stability

Additives (e.g. nitrogen-containing compounds) may improve coating solution stability (i.e. hold stability). Coating solution stability is a measure of a coating solution's ability to yield a transparent conductive film having consistent electrical conductivity (or surface resistivity) and haze as a function of the age of the coating. Solution age may, for example, be 0.1, 1, 2, 5, 7, or 14 days. It may be desirable that a coating solution yield a transparent conductive film having an electrical conductivity (or surface resistivity) and a haze that changes minimally, if at all, whether the age of the solution that is used to produce the transparent conductive film is 0.1, 1, 2, 5, 7, or 14 days. In this application, a property changes “minimally” if the difference between its first value (e.g. original value) and its second value (e.g. final value) is within 10%. In some cases, the differences may be within 5%, within 1%, etc.

The improvement in coating solution stability from inclusion of the additive relative to exclusion of the additive from the transparent conductive film may be determined by the difference in R×H at a particular solution age and R×H at an initial solution age of 0.1 day:

Coating Solution Stability=(R×H)ₜ₌ₓ−(R×H)_{t=0.1}

(R×H)ₜ₌ₓ is the product of surface resistivity and haze of a transparent conductive film that is produced by a coating solution having a solution age of t=x, where, for example, x=1, 2, 7, or 14 days.

(R×H)_{t=0.1} is the product of surface resistivity and haze of a transparent conductive film that is produced by a coating solution having a solution age of t=0.1 day.

(R×H)ₜ₌ₓ and (R×H)_{t=0.1} are based on two coating solutions, both having either the same or no test compound and being processed using the same drying temperature.

Additives yielding lower coating solution stability values may be indicative of their ability to provide a transparent conductive film with improved coating solution stability.

### Additives as Stabilization Agents

The use of nitrogen-containing additives may stabilize the transparent conductive film from, such as, atmospheric corrosion. The use of nitrogen containing compounds as stabilization agents are discussed in U.S. Patent Application Publication 2014/0199555, published Jul. 17, 2014, U.S. Patent Application Publication 2014/0255708, published Sep. 11, 2014, U.S. Patent Application Publication 2014/0072826, published Mar. 13, 2014, and PCT Patent Publication WO 2011/115603.

### Additives Comprising at Least One Nitrogen Atom

We have found that additives comprising at least one nitrogen atom when incorporated into silver nanowire containing films may improve the electrical conductivity, haze, or combination thereof (e.g. R×H) of such films. Such nitrogen-containing additives may also improve coating solution stability. Other benefits of nitrogen-containing compounds may be stabilizing the transparent conductive film from atmospheric corrosion.

A nitrogen-containing compound may be either a cyclic or acyclic compound (i.e. open-chain compound or open chain compound). A cyclic compound is a compound in which a series of atoms are connected to form a loop or ring. An acyclic compound is a compound with a linear structure rather than a cyclic structure.

In some embodiments, a nitrogen-containing additive may comprise an amine group. Amines may be classified as a primary amine, secondary amine, tertiary amine, or mixed amine. Amines are classified as primary, secondary, or tertiary based on the number of hydrogen atoms and organic substituents attached to the nitrogen atom. Such amines may be either cyclic or acyclic. A substituent is an atom or group of atoms substituted in place of a hydrogen atom on the parent chain of a hydrocarbon. A substituent may be a functional group or moiety. A functional group is a specific group of atoms or bonds within molecules that are responsible for characteristic chemical reactions of those molecules. A moiety is a part of a molecule that may include either whole functional groups or parts of functional groups as substructures.

A mixed amine is a compound that comprises at least two amine groups each of which belongs to a different classification. For example, a mixed amine may comprise a first amine group that is a secondary amine and a second amine group that is a tertiary amine.

A primary amine comprises a nitrogen atom attached to two hydrogen atoms and one organic substituent.

A primary amine has Structure I:

H₂N—R1 Structure I

where R1 may independently be one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, a substituted or unsubstituted aryloxy group comprising up to 10 carbons, an amino group (NR₂R₃) where R₂ and R₃ are independently a hydrogen, an alkyl group comprising up to 20 carbon atoms, or an aryl group comprising up to 10 carbon atoms, a thioether group (SR₄) where R₄ is an alkyl group comprising up to 20 carbon atoms, or an aryl group comprising up to 10 carbon atoms, a sulfoxy group (SOR₄), a sulfone group (SO₂R₄), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₂R₃), an acylamino group (NR₂COR₄), an acyl group (COR₄), an acyloxy group (OCOR₄), or a sulfonamido group (SO₂NR₂R₃).

A first exemplary primary amine is tert-butylamine, where R1 is (CH₃)₃C in Structure I, as shown in Structure II:

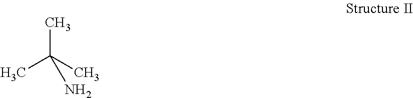

A second exemplary primary amine is benzylamine, where R1 is C₆H₅CH₂ in Structure I, as in Structure III:

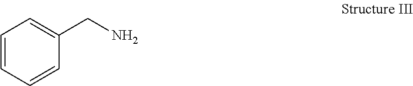

In some embodiments, a nitrogen-containing additive may comprise a secondary amine. A secondary amine comprises a nitrogen atom attached to one hydrogen atom and two organic substituents. A secondary amine may have Structure IV:

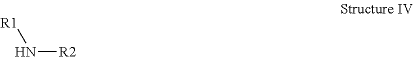

where R1 and R2 may be independently one of or connected with each other and together form a group that is selected from a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, a substituted or unsubstituted aryloxy group comprising up to 10 carbons, an amino group (NR₃R₄) where R₃ and R₄ are independently a hydrogen, an alkyl group comprising up to 20 carbon atoms, or an aryl group comprising up to 10 carbon atoms, a thioether group (SR₅) where R₅ is an alkyl group comprising up to 20 carbon atoms, or an aryl group comprising up to 10 carbon atoms, a sulfoxy group (SOR₅), a sulfone group (SO₃R₅), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₃R₄), an acylamino group (NR₃COR₅), an acyl group (COR₅), an acyloxy group (OCOR₅), or a sulfonamido group (SO₃NR₃R₄).

A first exemplary secondary amine is piperidine, where R1 and R2 in Structure IV are connected with each other and together form a six-membered ring containing five methylene bridges (—CH2-), as in Structure V:

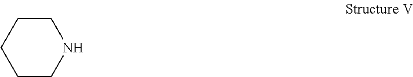

A second exemplary secondary amine is morpholine, where R1 and R2 in Structure IV are connected with each other and together form an alkoxy group O(CH₂CH₂)₂, as shown in Structure VI:

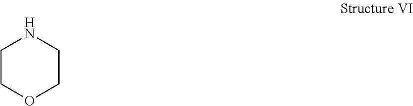

In some embodiments, a nitrogen-containing additive may comprise a tertiary amine. A tertiary amine comprises a nitrogen atom attached to three organic substituents. A tertiary amine has Structure VII:

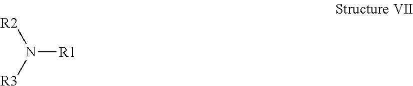

where any of R1, R2, and R3 may be independently one of or connected with each other and together form a group that is selected from a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a hydroxyalkyl group (R₆OH), a thiol group (SH), a substituted or unsubstituted alkoxy group comprising up to 20 carbon atoms, a substituted or unsubstituted aryloxy group comprising up to 10 carbons, an amino group (NR₄R₅) where R₄ and R₅ are independently a hydrogen, an alkyl group comprising up to 20 carbon atoms, or an aryl group comprising up to 10 carbon atoms, a thioether group (SR₆) where R₆ is an alkyl group comprising 1 up to 20 carbon atoms, or an aryl group comprising up to 10 carbon atoms, a sulfoxy group (SOR₆), a sulfone group (SO₄R₆), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₄R₅), an acylamino group (NR₄COR₆), an acyl group (COR_{E}), an acyloxy group (OCOR₆), or a sulfonamido group (SO₄NR₄R₅).

A first exemplary embodiment of a tertiary amine is triethylamine, where R1, R2, and R3 are each CH₃ in Structure VII, as shown in Structure VIII:

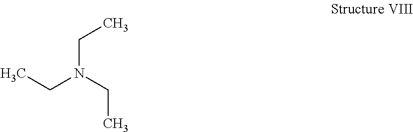

A second exemplary embodiment of a tertiary amine is N,N-diisopropylethylamine, wherein R1 is CH(CH₃)₂, R2 is CH(CH₃)₂, and R3 is C₂H₅ in Structure VII, as shown in Structure IX:

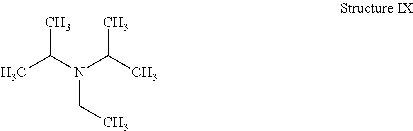

A third exemplary embodiment of a tertiary amine is N-methyldiethanolamine, where R1 is CH₃ and R2 and R3 are each CH₂CH₂OH in Structure VII, as shown in Structure X:

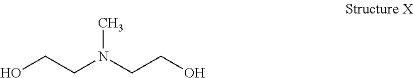

A fourth exemplary embodiment of a tertiary amine is 4-(2-hydroxyethyl)morpholine, where R1 is (CH₂)₂OH and R2 and R3 connect with each other and together form an alkoxy group O(CH₂CH₂)₂, as shown in Structure XI:

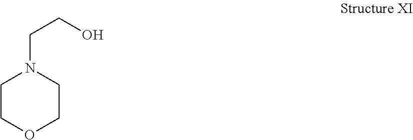

A fifth exemplary embodiment of a tertiary amine is 4-methylmorpholine, where R1 is CH3 and R2 and R3 connect with each other and together form an alkoxy group O(CH₂CH₂)₂, as shown in Structure XII:

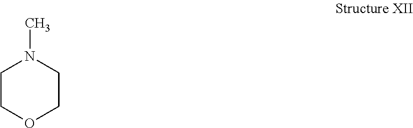

In some embodiments, a nitrogen-containing additive may comprise a mixed amine. A mixed amine is a compound that comprises at least two amine groups each of which belongs to a different classification (i.e. primary, secondary, or tertiary amines).

A first exemplary mixed amine is 1-(2-aminoethyl)-piperazine, as shown in Structure XIII:

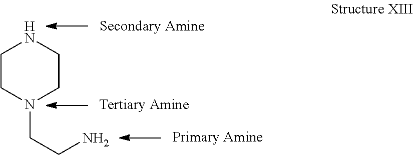

A second exemplary mixed amine is N,N-diethylethylenediamine, as shown in Structure XIV:

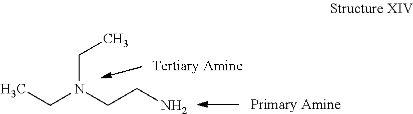

In some embodiments, a nitrogen-containing additive may comprise a nitrogen heterocyclic compound. A heterocyclic compound is a cyclic compound that has atoms of at least two different elements as members of its ring(s).

In some embodiments, a nitrogen heterocyclic compound may comprise an optionally modified imidazole, such as that shown in Structure XV:

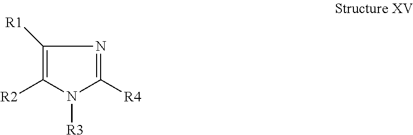

where any of R1, R2, R3, and R4 may be independently one of a hydrogen, a substituted or unsubstituted alkyl group comprising up to 20 carbon atoms, a substituted or unsubstituted aryl group comprising up to 10 carbon atoms, a substituted or unsubstituted alkylaryl group comprising up to 30 carbon atoms, a substituted or unsubstituted heteroaryl group comprising up to 10 carbon, oxygen, nitrogen, or sulfur atoms, a halogen atom (F, Cl, Br, or I), a hydroxyl group (OH), a hydroxyalkyl group (R₇OH), a thiol group (SH), a substituted or unsubstituted alkoxy group comprising up to 20 carbon atoms, a substituted or unsubstituted aryloxy group comprising up to 10 carbons, an amino group (NR₅R₆) where R₅ and R₆ are independently a hydrogen, an alkyl group comprising up to 20 carbon atoms, or an aryl group comprising up to 10 carbon atoms, a thioether group (SR₇) where R₇ is an alkyl group comprising 1 up to 20 carbon atoms, or an aryl group comprising up to 10 carbon atoms, a sulfoxy group (SOR_{A}), a sulfone group (SO₅R₇), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₅R₆), an acylamino group (NR₅COR₇), an acyl group (COR₇), an acyloxy group (OCOR₇), or a sulfonamido group (SO₅NR₅R₆).

A first exemplary optionally modified imidazole is imidazole, where R1, R2, R3, and R4 are each hydrogen atoms, as shown in Structure XVI:

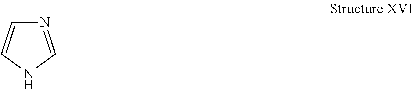

A second exemplary optionally modified imidazole is 1-decyl-2-methyl-imidazole, where R1 and R2 are each hydrogen atoms, R3 is CH₂(CH₂)₈CH₃, and R4 is CH₃, as shown in Structure XVII:

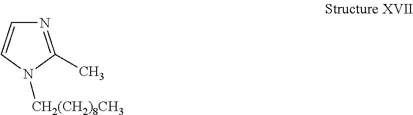

In some embodiments, a nitrogen heterocyclic compound may be an optionally modified pyridine-containing compound, such as that shown in Structure XVIII:

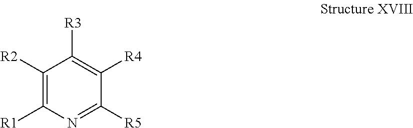

where R1, R2, R3, R4, and R5 are independently one of or connected with one of the other R1, R2, R3, R4, and R5 and together form a hydrogen, a substituted or unsubstituted alkyl group comprising up to 20 carbon atoms, a substituted or unsubstituted aryl group comprising up to 10 carbon atoms, a substituted or unsubstituted cyclic compound comprising up to 10 carbon atoms, a substituted or unsubstituted alkylaryl group comprising up to 30 carbon atoms, a substituted or unsubstituted heteroaryl group comprising up to 10 carbons, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, a substituted or unsubstituted aryloxy group comprising up to 10 carbons, an amino group (NR₆R₇) where R₆ and R₇ are independently a hydrogen, an alkyl group comprising up to 20 carbon atoms, or an aryl group comprising up to 10 carbon atoms, a thioether group (SR₈) where R₈ is an alkyl group comprising up to 20 carbon atoms, or an aryl group comprising up to 10 carbon atoms, a sulfoxy group (SOR₈), a sulfone group (SO₆R₈), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₆R₇), an acylamino group (NR₆COR₈), an acyl group (COR₈), an acyloxy group (OCOR₈), or a sulfonamido group (SO₆NR₆R₇).

A first exemplary optionally modified pyridine-containing compound is pyridine, where R1, R2, R3, R4, and R5 are each hydrogen atoms in Structure XVIII, as shown in Structure XIX:

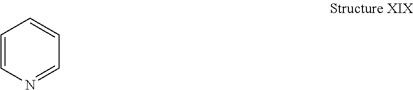

A second exemplary optionally modified pyridine-containing compound is 4-picoline, where R1, R2, R4, and R5 are each hydrogen atoms and R3 is a methyl group (CH₃) in Structure XVIII, as shown in Structure XX:

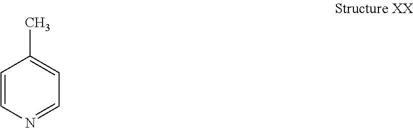

A third exemplary optionally modified pyridine-containing compound is 2-picoline, where R1, R2, R3, and R4 are each hydrogen atoms and R5 is a methyl group (CH₃) in Structure XVIII, as shown in Structure XXI:

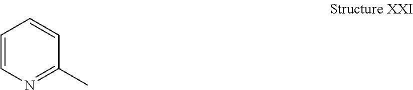

A fourth exemplary optionally modified pyridine-containing compound is 2,6-Lutidine, where R1 and R5 are each methyl groups (CH₃) and R2, R3, and R4 are each hydrogen atoms in Structure XVIII, as shown in Structure XXII:

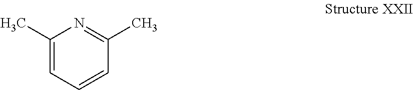

In some embodiments, a nitrogen heterocyclic compound may be an optionally modified pyrimidine-containing compound, such as that shown in Structure XXIII:

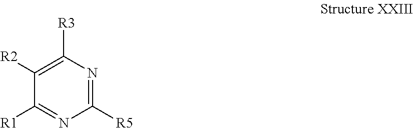

where R1, R2, R3, and R5 are independently one of or connected with one of the other R1, R2, R3, and R5 and together form a hydrogen, a substituted or unsubstituted alkyl group comprising up to 20 carbon atoms, a substituted or unsubstituted aryl group comprising up to 10 carbon atoms, a substituted or unsubstituted cyclic compound comprising up to 10 carbon atoms, a substituted or unsubstituted alkylaryl group comprising up to 30 carbon atoms, a substituted or unsubstituted heteroaryl group comprising up to 10 carbons, oxygen, nitrogen, or sulfur atoms, a halogen atom (F, Cl, Br, or I), a hydroxyl group (OH), a thiol group (SH), a substituted or unsubstituted alkoxy group comprising up to 20 carbon atoms, a substituted or unsubstituted aryloxy group comprising up to 10 carbons, an amino group (NR₆R₇) where R₆ and R₇ are independently a hydrogen, an alkyl group comprising up to 20 carbon atoms, or an aryl group comprising up to 10 carbon atoms, a thioether group (SR₈) where R₈ is an alkyl group comprising up to 20 carbon atoms, or an aryl group comprising up to 10 carbon atoms, a sulfoxy group (SOR₈), a sulfone group (SO₆R₈), a carboxylic acid group (COOH) or a salt of a carboxylic acid (CO₂⁻M⁺) where M⁺ is a cation (such as a metal cation, a quaternary ammonium cation or a quaternary phosphonium cation), a carboxamide group (CONR₆R₇), an acylamino group (NR₆COR₈), an acyl group (COR₈), an acyloxy group (OCOR₈), or a sulfonamido group (SO₆NR₆R₇).

An exemplary optionally modified pyrimidine-containing compound is 4-methylpyrimidine, where R1, R2, and R5 are each hydrogen atoms and R3 is a methyl group (CH₃), as shown in Structure XXIV:

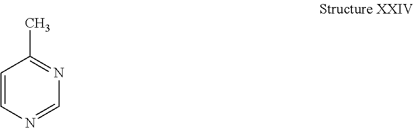

Nitrogen Containing Compounds and their Tautomers, Mesomers, and Isomers

It should be understood that when nitrogen containing compounds are referred to or claimed in this application, their related tautomeric, mesomeric, and isomeric (e.g. structural isomeric, skeletal isomeric, stereoisomeric, constitutional isomeric) forms are also included in the reference or claim.

### Coating of the Conductive Films

An organic solvent-based coating formulation for the transparent silver nanowire films can be prepared by mixing the various components with one or more polymer binders in a suitable organic solvent system that usually includes one or more solvents such as toluene, 2-butanone (methyl ethyl ketone, MEK), methyl iso-butyl ketone, acetone, methanol, ethanol, 2-propanol, ethyl acetate, propyl acetate, butyl acetate, ethyl lactate, tetrahydrofuran, or mixtures thereof. An aqueous-based coating formulation for the transparent silver nanowire films can be prepared by mixing the various components with one or more polymer binders in water or in a mixture of water with a water miscible solvent such as acetone, acetonitrile, methanol, ethanol, 2-propanol, or tetrahydrofuran, or mixtures thereof. Transparent films containing silver nanowires can be prepared by coating the formulations using various coating procedures such as wire wound rod coating, dip coating, knife or blade coating, curtain coating, slide coating, slot-die coating, roll coating, or gravure coating. Surfactants and other coating aids can be incorporated into the coating formulation.

In one embodiment the coating weight of the silver nanowires is from about 10 mg/m² to about 500 mg/m². In another embodiment the coating weight of silver nanowires is from about 20 mg/m² to about 200 mg/m². In a further embodiment, the coating weight of silver nanowires is from about 30 mg/m² to about 120 mg/m². A useful coating dry thickness of the transparent conductive coating is from about 0.05 μm to about 2.0 μm, and preferably from about 0.1 μm to about 0.5 μm.

Upon coating and drying, the transparent conductive film should have a surface resistivity of less than 1,000 ohms/sq and preferably less than 500 ohm/sq.

Upon coating, and drying, the transparent conductive film should have as high a % transmittance as possible. A transmittance of at least 70% is useful. A transmittance of at least 80% and even at least 90% are even more useful.

Particularly useful are films with a transmittance of at least 70% and a surface resistivity of less than 500 ohm/sq.

Such transparent conductive films provide transmittance of at least 80% across entire spectrum range of from about 350 nm to about 1100 nm, and surface resistivity of less than 500 ohm/sq.

### Transparent Support

In one embodiment, the conductive materials are coated onto a support. The support may be rigid or flexible. Suitable rigid substrates include, for example, glass, polycarbonates, acrylics, and the like.

When the conductive materials are coated onto a flexible support, the support is preferably a flexible, transparent polymeric film that has any desired thickness and is composed of one or more polymeric materials. The support is required to exhibit dimensional stability during coating and drying of the conductive layer and to have suitable adhesive properties with overlying layers. Useful polymeric materials for making such supports include polyesters [such as poly(ethylene terephthalate) (PET) and poly(ethylene naphthalate) (PEN)], cellulose acetates and other cellulose esters, polyvinyl acetal, polyolefins, polycarbonates, and polystyrenes. Preferred supports are composed of polymers having good heat stability, such as polyesters and polycarbonates. Support materials may also be treated or annealed to reduce shrinkage and promote dimensional stability. Transparent multilayer supports can also be used.

Coating of the Conductive Films onto a Support

Transparent conductive articles can be prepared by coating the formulations described above onto a transparent support using various coating procedures such as wire wound rod coating, dip coating, knife coating, curtain coating, slide coating, slot-die coating, roll coating, gravure coating, or extrusion coating.

Alternatively, transparent conductive articles can be prepared by laminating the transparent conductive films prepared as described above onto a transparent support.

In some embodiments, a “carrier” layer formulation comprising a single-phase mixture of two or more polymers may be applied directly onto the support and thereby located between the support and the silver nanowire layer. The carrier layer serves to promote adhesion of the support to the transparent polymer layer containing the silver nanowires. The carrier layer formulation can be sequentially or simultaneously applied with application of the transparent conductive silver nanowire layer formulation. It is preferred that all coating be applied simultaneously onto the support. Carrier layers are often referred to as “adhesion promoting layers,” “interlayers,” or “intermediate layers.”

As noted above, in one embodiment the coating weight of the silver nanowires is from about 20 mg/m² to about 500 mg/m². In other embodiments, coating weight of silver nanowires is from about 10 mg/m² to about 200 mg/m². Embodiments wherein the silver nanowires are coated at from about 10 mg/m² to about 120 mg/m² are also contemplated.

Upon coating and drying, the transparent conductive article should have a surface resistivity of less than 1,000 ohms/sq and preferably less than 500 ohm/sq.

Similarly, upon coating and drying on a transparent support, the transparent conductive article should have as high an optical transmittance as possible. A transmittance of at least 70% is useful. A transmittance of at least 80% and even at least 90% are even more useful.

Particularly preferred are articles with a transmittance of at least 80% and a surface resistivity of less than 500 ohm/sq.

### EXEMPLARY EMBODIMENTS

U.S. Provisional Application No. 61/976,542, filed Apr. 8, 2014, entitled “NITROGEN-CONTAINING COMPOUNDS AS ADDITIVES FOR TRANSPARENT CONDUCTIVE FILMS,” which is hereby incorporated by reference in its entirety, disclosed the following 53 non-limiting exemplary embodiments:

A. A transparent conductive article comprising:

a transparent support; and

at least one first layer disposed on the transparent support, the at least one first layer comprising a network of silver nanowires dispersed within at least one polymer binder;

wherein the transparent conductive article comprises one or more additives, the one or more additives comprising at least one amine compound.

B. The transparent conductive article according to embodiment A, wherein the at least one first layer comprises the one or more additives, the one or more additives comprising at least one amine compound.
C. The transparent conductive article according to either of embodiments A or B, further comprising at least one second layer, wherein the at least one second layer comprises the one or more additives, the one or more additives comprising at least one amine compound.
D. The transparent conductive article according to any of embodiments A-C, wherein the at least one amine compound comprises at least one primary amine.
E. The transparent conductive article according to any of embodiments A-D, wherein the at least one amine compound comprises at least one secondary amine.
F. The transparent conductive article according to any of embodiments A-E, wherein the at least one amine compound comprises at least one tertiary amine.
G. The transparent conductive article according to any of embodiments A-F, wherein the one or more additives comprising at least one amine compound comprises a mixed amine, the mixed amine comprising a first amine and a second amine selected from the classification group consisting of a primary amine, a secondary amine, and a tertiary amine, the classification group of the first amine being different from the classification group of the second amine.
H. The transparent conductive article according to any of embodiments A-G, wherein the at least one amine compound comprises tert-butylamine.
J. The transparent conductive article according to any of embodiments A-H, wherein the at least one amine compound comprises benzylamine.
K. The transparent conductive article according to any of embodiments A-J, wherein the at least one amine compound comprises piperidine.
L. The transparent conductive article according to any of embodiments A-K, wherein the at least one amine compound comprises morpholine.
M. The transparent conductive article according to any of embodiments A-L, wherein the at least one amine compound comprises triethylamine.
N. The transparent conductive article according to any of embodiments A-M, wherein the at least one amine compound comprises N,N-diisopropylethylamine.
P. The transparent conductive article according to any of embodiments A-N, wherein the at least one amine compound comprises N-methyldiethanolamine.
Q. The transparent conductive article according to any of embodiments A-P, wherein the at least one amine compound comprises 4-(2-hydroxylethyl)morpholine.
R. The transparent conductive article according to any of embodiments A-Q, wherein the at least one amine compound comprises 4-methylmorpholine.
S. The transparent conductive article according to any of embodiments A-R, wherein the at least one amine compound comprises 1-(2-aminoethyl)-piperazine.
T. The transparent conductive article according to any of embodiments A-S, wherein the at least one amine compound comprises N,N-diethylethylenediamine.
U. The transparent conductive article according to any of embodiments A-T, wherein the at least one second layer is disposed on the at least one first layer.
V. A transparent conductive article comprising:

a transparent support;

at least one first layer disposed on the transparent support, the at least one first layer comprising a network of silver nanowires dispersed within at least one polymer binder;

wherein the transparent conductive article comprises one or more additives, the one or more additives comprising at least one nitrogen heterocyclic compound selected from the group consisting of 1-decyl-2-methyl-imidazole, pyridine-containing compound, and pyrimidine-containing compound.

W. The transparent conductive article according to embodiment V, wherein the at least one first layer comprises the one or more additives, the one or more additives comprising at least one nitrogen heterocyclic compound selected from the group consisting of 1-decyl-2-methyl-imidazole, pyridine-containing compound, and pyrimidine-containing compound.
X. The transparent conductive article according to either of embodiments V or W, further comprising at least one second layer, wherein the at least one second layer comprises the one or more additives, the one or more additives comprising at least one nitrogen heterocyclic compound selected from the group consisting of 1-decyl-2-methyl-imidazole, pyridine-containing compound, and pyrimidine-containing compound.
Y. The transparent conductive article according to any of embodiments V-X, wherein the at least pyridine-containing compound comprises pyridine.
Z. The transparent conductive article according to any of embodiments V-Y, wherein the at least pyridine-containing compound comprises 4-picoline.
AA. The transparent conductive article according to any of embodiments V-Z, wherein the at least pyridine-containing compound comprises 2-picoline.
AB. The transparent conductive article according to any of embodiments V-AA, wherein the at least pyridine-containing compound comprises 2,6-lutidine.
AC. The transparent conductive article according to any of embodiments V-AB, wherein the at least pyrimidine-containing compound comprises 4-methylpyrimidine.
AD. The transparent conductive article according to any of embodiments 1-AC, wherein the silver nanowires are present in an amount sufficient to provide a surface resistivity of less than 1000 ohm/sq.
AE. The transparent conductive article according to any of embodiments A-AD, wherein the silver nanowires have an aspect ratio of from about 20 to about 3300.
AF. The transparent conductive article according to any of embodiments A-AE, wherein the silver nanowires are present in an amount of from about 10 mg/m² to about 500 mg/m².
AG. The transparent conductive article according to any of embodiments A-AF further having a transmittance of at least 80% across entire spectrum range of from about 350 nm to about 1100 nm and a surface resistivity of 500 ohm/sq or less.
AH. The transparent conductive article according to any of embodiments A-AG, wherein the at least one polymer binder comprises at least one water soluble polymer.
AJ. The transparent conductive article according to embodiment AH, wherein the at least one water soluble polymer comprises gelatin, polyvinyl alcohol, or mixtures thereof.
AK. The transparent conductive article according to any of embodiments A-AJ, wherein the at least one polymer binder further comprises up to 50 wt % of one or more additional water soluble polymers.
AL. The transparent conductive article according to embodiment AK, wherein one or more of the additional water soluble polymers is a polyacrylic polymer
AM. The transparent conductive article according to any of embodiments A-AL, wherein the at least one polymer binder comprises at least one organic solvent soluble polymer.
AN. The transparent conductive article according to embodiment AM, wherein the at least one organic solvent soluble polymer binder comprises at least one cellulose ester polymer.
AP. The transparent conductive article according to either of embodiments AM or AN, wherein the at least one organic solvent soluble polymer binder comprises cellulose acetate, cellulose acetate butyrate, or cellulose acetate propionate, or mixtures thereof.
AQ. The transparent conductive article according to any of embodiments AM-AP, wherein the at least one cellulose ester polymer has a glass transition temperature of at least 100° C.
AR. The transparent conductive article according to any of embodiments A-AQ, wherein the at least one polymer binder further comprises up to 50 wt % of one or more additional organic solvent soluble polymers.
AS. The transparent conductive article according to any of embodiments AM-AR, wherein the one or more additional organic solvent soluble polymers is a polyester polymer.
AT. The transparent conductive article according to embodiment X, wherein the at least one second layer is disposed on the at least one first layer.
AU. A method of forming a transparent conductive article comprising:

applying at least one first coating mixture onto a transparent support to form at least one first coated layer, the at least one first coating mixture comprising silver nanowires and at least one polymer binder;

wherein the transparent conductive article comprises one or more additives, the one or more additives comprising at least one amine group or at least one nitrogen heterocyclic compound selected from the group consisting of 1-decyl-2-methyl-imidazole, pyridine-containing compound, and pyrimidine-containing compound.

AV. The method according to embodiment AU, further comprising applying at least one second coating mixture to form at least one second coated layer, wherein the applying the at least one first coating mixture and the applying the at least one second coating mixture occur simultaneously.
AW. The method according to either of embodiments AU or AV, further comprising

applying at least one second coating mixture to form at least one second coated layer, and

drying the at least one first layer or the at least one second layer or both.

AX. The method according to any of embodiments AU-AW, wherein the at least one first layer comprises the one or more additives, the one or more additives comprising at least one nitrogen heterocyclic compound selected from the group consisting of 1-decyl-2-methyl-imidazole, pyridine-containing compound, and pyrimidine-containing compound.
AY. The method according to either of embodiments AU or AV, wherein the at least one second layer comprises the one or more additives, the one or more additives comprising at least one nitrogen heterocyclic compound selected from the group consisting of 1-decyl-2-methyl-imidazole, pyridine-containing compound, and pyrimidine-containing compound.
AZ. The method according to embodiment AV, wherein the at least one second coated layer is disposed onto the at least one first coated layer.
BA. A method comprising:

comparing a first multiplicative product of surface resistivity and haze for a first transparent conductive article having a first surface resistivity and a first haze made from a first coating solution at a first solution age using a first drying temperature with a second multiplicative product of surface resistivity and haze for a second transparent conductive article having a second surface resistivity and a second haze made from a second coating solution at a second solution age using a second drying temperature.

BB. The method of embodiment BA, wherein the first coating solution comprises a first additive and the second coating solution comprises a second additive, the first additive and the second additive being different.
BC. The method of according to either embodiments BA or BB, wherein the first coating solution comprises a first nitrogen containing compound and the second coating solution comprises a second nitrogen containing compound, the first nitrogen containing compound and the second nitrogen containing compound being different.
BD. The method of embodiment BA, wherein the first coating solution has no nitrogen containing compound and the second coating solution comprises a nitrogen containing compound.
BE. The method according to any of embodiments BA-BD, further comprising calculating the difference between the first multiplicative product and the second multiplicative product,

wherein the first coating solution has no nitrogen containing compound and the second coating solution comprises a nitrogen containing compound,

wherein the first solution age and the second solution age are the same, and

wherein the first drying temperature and the second drying temperature are the same.

### EXAMPLES

### Materials

The following additional methods and materials were used.

CAB 381-20 is a cellulose acetate butyrate resin available from Eastman Chemical Co. (Kingsport, Tenn.). It has a glass transition temperature of 141° C.

n-propyl acetate is available from Oxea Corp.

Isopropanol (“IPA”) and ethyl lactate (>99.8% purity) are available from standard commercial sources, such as Sigma-Aldrich Co. LLC (St. Louis, Mo.).

5 mil ESTAR® LS (low shrinkage) polyester support is available from Eastman Kodak Co. (Rochester, N.Y.).

1-decyl-2-methyl-imadazole (DMI) is available from Sigma-Aldrich Co. LLC (St. Louis, Mo.).

4-picoline (4PIC) is available from Sigma-Aldrich Co. LLC (St. Louis, Mo.).

2-picoline (2PIC) is available from Sigma-Aldrich Co. LLC (St. Louis, Mo.).

Pyridine (PYR) is available from Sigma-Aldrich Co. LLC (St. Louis, Mo.).

4-methylpyrimidine (4MP) is available from Sigma-Aldrich Co. LLC (St. Louis, Mo.).

2,6-lutidine (LUT) (≧99% purity) is available from Sigma-Aldrich Co. LLC (St. Louis, Mo.). Triethylamine (TEA) (reagent grade) is available from Fisher Scientific International Inc. (Hampton, N.H.). It has a boiling point of 89° C.

N,N-diisopropylethylamine (DIEA) (≧98% purity) is available from Acros Organics, part of Thermo Fisher Scientific (NJ). It has a boiling point of 127° C.

N-methyldiethanolamine (MDEA) (99% purity) is available from Sigma-Aldrich Co. LLC (St. Louis, Mo.). It has a boiling point of 247° C.

4-(2-hydroxyethyl)morpholine (HEMORP) (99% purity) is available from Sigma-Aldrich Co. LLC (St. Louis, Mo.). It has a boiling point of 227° C. at a pressure of 757 mmHg.

4-methylmorpholine (MMORP) (99% purity) is available from Sigma-Aldrich Co. LLC (St. Louis, Mo.). It has a boiling point of 115-116° C. at a pressure of 750 mmHg.

Piperidine (PIP) is available from Fisher Scientific International Inc. (Hampton, N.H.). It has a boiling point of 106° C. and is available under the tradename FisherBiotech™.

Morpholine (MORP) (certified ACS) is available from Fisher Scientific International Inc. (Hampton, N.H.). It has a boiling point of 129° C.

Tert-butylamine (TBuA) is available from Sigma-Aldrich Co. LLC (St. Louis, Mo.). It is has a boiling point of 46° C.

Benzylamine (BZAM) (99% purity) is available from Sigma-Aldrich Co. LLC (St. Louis, Mo.). It has a boiling point of 184-185° C.

1-(2-aminoethyl)-piperazine (AEPIP) (99% purity) is available from Sigma-Aldrich Co. LLC (St. Louis, Mo.). It has a boiling point of 220° C.

N,N-diethylethylenediamine (DEEDA) (99% purity) is available from Sigma-Aldrich Co. LLC (St. Louis, Mo.). It has a boiling point of 143-145° C.

### Example 1

### Silver Nanowires

Silver nanowires were made according to the procedures described in US Patent Application Publication 2014/0123808, published May 8, 2014, entitled NANOWIRE PREPARATION METHODS, COMPOSITIONS, AND ARTICLES, which is hereby incorporated by reference in its entirety. Silver nanowires so prepared, exhibiting average diameters of about 33 nm and approximate lengths ranging from 13-17 μm, were used in Examples 1 and 2.

### Preparation of Silver Nanowire Conductive Films

A CAB polymer premix solution was prepared by mixing 5 parts by weight of CAB 381-20 with 95 parts by weight of n-propyl acetate. The resulting CAB polymer premix solution was filtered prior to use.

To prepare the comparative (“COM”) samples, 35.08 parts by weight of a 1.85% solids dispersion of silver nanowires in IPA was combined with 8.91 parts by weight of IPA. To prepare the samples with test compounds (TC), varying amounts of TC were dissolved in IPA prior to combination with the dispersion of silver nanowires. Tables I-III show the ratio of silver nanowires to test compound in terms of weight (g/g).

To either of these samples, 38.94 parts by weight of the CAB polymer premix solution, 8.65 parts by weight of ethyl lactate, and 8.42 parts by weight of n-propyl acetate were added to form silver nanowire coating dispersions having 2.60% solids.

The finished silver nanowire coating dispersions were coated on a lab proofer with a 420 LPI (lines per inch) plate onto 5 mil ESTAR® LS polyester supports and dried at 275° F. for 2 min.

### Evaluation of Silver Nanowire Conductive Films

Surface resistivity was measured immediately after coating using either an RCHEK model RC2175 4-Point Surface Resistivity meter, available from Electronic Design To Market, Inc. (Toledo, Ohio), or a DELCOM 707 non-contact conductance monitor, available from Delcom Instruments, Inc. (Minneapolis, Minn.). Haze was also measured immediately after coating using a Byk Haze-gard Plus. R×H calculations, which are a multiplicative product of surface resistivity and percent haze, were performed for the samples. Tables I and II show the R×H values for several nitrogen-containing test compounds.

Referring to Table I, the R×H values for the various nitrogen-containing test compounds (e.g. 1-decyl-2-methyl-imidazole, 4-picoline, 2-picoline, pyridine, 4-methylpyrimidine, and 2,6-lutidine) were generally lower than the R×H values of their respective comparative samples, except for 4-methylpyrimidine at a ratio of wires to test compound of 17 to 1. Such test compounds with R×H values that are lower than the R×H values of their respective comparative samples (other than 4-methylpyrimidine at a ratio of wires to test compound of 17 to 1) may be indicative of their ability to provide a transparent conductive article that has an improved combination of electrical conductivity and haze. The R×H value for pyridine at a ratio of wires to test compound of 17 to 1 is slightly lower than the R×H value of its respective comparative sample and may prove to be a negligible difference.

Referring to Table II, the R×H values for the various nitrogen-containing test compounds (e.g. triethylamine, N,N-diisopropylethylamine, N-methyldiethanolamine, 4-(2-hydroxyethyl)morpholine, morpholine, tert-butylamine, benzylamine, 1-(2-aminoethyl)-piperazine) were generally lower than the R×H values of their respective comparative samples, except for piperidine. Such test compounds with R×H values that are lower than the R×H values of their respective comparative samples (other than piperidine) may be indicative of their ability to provide a transparent conductive article that has an improved combination of electrical conductivity and haze.

TABLE I

| | | Ratio of | | | |
|---|---|---|---|---|---|
| | | Wires to | Initial | | |
| | | Test | Surface | | |
| | Test | Compound | Resistivity | Haze | |
| Sample | Compound | (g/g) | (ohms/sq) | (percent) | R × H |
| Com-1-1 | None | None | 78 | 1.10 | 85.80 |
| 1-1 | DMI | 17/1 | 76 | 1.01 | 76.76 |
| 1-2 | DMI | 5/1 | 81 | 0.97 | 78.57 |
| Com-1-2 | None | None | 87 | 1.13 | 98.31 |
| 1-3 | 4PIC | 17/1 | 79 | 1.06 | 83.74 |
| 1-4 | 4PIC | 5/1 | 77 | 1.00 | 77.00 |
| 1-5 | 2PIC | 17/1 | 78 | 0.98 | 76.44 |
| 1-6 | 2PIC | 5/1 | 78 | 0.99 | 77.22 |
| Com-1-3 | None | None | 81 | 1.10 | 89.10 |
| 1-7 | PYR | 17/1 | 80 | 1.09 | 87.20 |
| 1-8 | PYR | 5/1 | 78 | 0.99 | 77.22 |
| 1-9 | PYR | 2.5/1 | 75 | 0.96 | 72.00 |
| 1-10 | 4MP | 17/1 | 79 | 1.13 | 89.27 |
| 1-11 | 4MP | 5/1 | 76 | 1.04 | 79.04 |
| 1-12 | 4MP | 2.5/1 | 79 | 0.95 | 75.05 |
| 1-13 | LUT | 17/1 | 78 | 1.00 | 78.00 |
| 1-14 | LUT | 5/1 | 75 | 1.00 | 75.00 |
| 1-15 | LUT | 2.5/1 | 80 | 0.99 | 79.20 |

DMI = 1-decyl-2-methyl-imidazole
4PIC = 4-Picoline
2PIC = 2-Picoline
PYR = Pyridine
4MP = 4-Methylpyrimidine
LUT = 2,6-Lutidine

TABLE II

| | | Ratio of | | | |
|---|---|---|---|---|---|
| | | Wires to | Initial | | |
| | | Test | Surface | | |
| | Test | Compound | Resistivity | Haze | |
| Sample | Compound | (g/g) | (ohms/sq) | (percent) | R × H |
| Com-2-1 | None | None | 102 | 0.80 | 81.60 |
| 2-1 | TEA | 5/1 | 81 | 0.86 | 69.66 |
| 2-2 | DIEA | 5/1 | 84 | 0.85 | 71.40 |
| Com-2-2 | None | None | 101 | 0.86 | 86.86 |
| 2-3 | HEMORP | 5/1 | 88 | 0.86 | 75.68 |
| 2-4 | MMORP | 5/1 | 96 | 0.87 | 83.52 |
| Com-2-3 | None | None | 107 | 0.92 | 98.44 |
| 2-5 | MDEA | 5/1 | 97 | 0.89 | 86.33 |
| Com-2-4 | None | None | 104 | 0.79 | 82.16 |
| 2-6 | PIP | 5/1 | 102 | 0.82 | 83.64 |
| Com-2-5 | None | None | 97 | 0.81 | 78.57 |
| 2-7 | MORP | 5/1 | 93 | 0.81 | 75.33 |
| Com-2-6 | None | None | 104 | 0.79 | 86.86 |
| 2-8 | TBuA | 5/1 | 127 | 0.89 | 81.81 |
| Com-2-7 | None | None | 101 | 0.86 | 82.16 |
| 2-9 | BZAM | 5/1 | 101 | 0.81 | 73.87 |
| Com-2-8 | None | None | 101 | 0.86 | 86.86 |
| 2-10 | DEEDA | 5/1 | 91 | 0.87 | 79.17 |

TEA = triethylamine
DIEA = N,N-Diisopropylethylamine
MDEA = N-Methyldiethanolamine
HEMORP = 4-(2-hydroxyethyl)morpholine
MMORP = 4-Methylmorpholine
PIP = Piperidine
MORP = Morpholine
TBuA = tert-Butylamine
BZAM = Benzylamine
AEPIP = 1-(2-Aminoethyl)-piperazine

### Example 2

The silver nanowire conductive films were prepared following a similar method as described in Example 1. Two batches of silver nanowire coating dispersions were prepared. To test for coating solution stability, each batch of the silver nanowire coating dispersions was stored in the dark for a certain amount of potlife (t=0.1, 1, 2, 5, 7, or 14 days) and shaken for 5 minutes before being coated on a lab proofer with a 420 LPI plate onto 5 mil ESTAR® LS polyester supports. The silver nanowire coating dispersions that were not stored in the dark took two to three hours to coat, which is designated as initial solution age of t=0.1 day. The first batch of silver nanowire coating dispersions was dried on supports at 275° F. for 2 minutes. The second batch of silver nanowire coating dispersions was dried on supports at 160° F. for 2 minutes. The surface resistivity and haze were measured immediately after coating using the machinery as described in Example 1. Coating solution stability calculations were performed for the samples. The coating solution stability is based on the difference in R×H at a particular solution age and R×H at an initial solution age of t=0.1 day for a coating solution containing the same or no test compound and processed at the same drying temperature. Thus, the R×H of the samples at an initial solution age of t=0.1 day was used to calculate the R×H of the samples at solution ages other than t=0.1 day, given the test compound or lack thereof in the samples and the drying temperatures were the same. Tables III and IV show the Δ(R×H) values for several nitrogen-containing test compounds.

Referring to Table III, at either drying temperature of 275° F. or 160° F., the absolute value of Δ(R×H) of 4-(2-hydroxyethyl)morpholine at solution ages t=1, 7, and 14 days were lower than the absolute value of Δ(R×H) of the respective comparative sample at the same solution ages t=1, 7, and 14 days, respectively. Such Δ(R×H) values for 4-(2-hydroxyethyl)morpholine may generally indicate that addition of 4-(2-hydroxyethyl)morpholine in a coating solution may yield a transparent conductive film having relatively consistent electrical conductivity and haze even if produced with a coating solution that has solution ages t=1, 7, and 14 days. At a solution age of t=2 days, the absolute value of Δ(R×H) of 4-(2-hydroxyethyl)morpholine is slightly higher than the absolute value of Δ(R×H) of the respective comparative sample. Such difference may prove to be negligible. At either drying temperature of 275° F. or 160° F., the absolute value of Δ(R×H) of 4-methylmorpholine at solution ages 7 and 14 days were lower than the absolute value of Δ(R×H) of the respective comparative sample at the same solution ages t=7 and 14 days, respectively. Such Δ(R×H) values for 4-methylmorpholine may generally indicate that addition of 4-methylmorpholine in a coating solution may yield a transparent conductive film having relatively consistent electrical conductivity and haze even if produced with a coating solution that has solution ages t=7 and 14 days. For benzylamine, the absolute value of Δ(R×H) were generally not lower than that of respective comparative samples. This may suggest that benzylamine as an additive to a coating solution may not improve the coating solution stability.

Referring to Table IV, at a drying temperature of 275° F., the absolute values of Δ(R×H) for triethylamine at a ratio of wires to test compound is 10 to 1 were generally either close or higher than the absolute value of Δ(R×H) of respective comparative samples. However, at a drying temperature of 160° F., the absolute values of Δ(R×H) for triethylamine at a ratio of wires to test compound of 10 to 1 were lower than the absolute value of Δ(R×H) of respective comparative samples. It appears that triethylamine at a ratio of wires to test compound of 10 to 1 as an additive to a coating solution may improve the coating solution stability at a drying temperature of 160° F., but this might not be as true at a drying temperature of 275° F. At a drying temperature of 275° F., the absolute values of Δ(R×H) for triethylamine at a ratio of wires to test compound is 5 to 1 were lower for solution ages t=1 and 5 days but higher for solution age t=2 days than that of the respective comparative examples. At a drying temperature of 160° F., the absolute values of Δ(R×H) for triethylamine at a ratio of wires to test compound is 5 to 1 were lower than that of the respective comparative examples. It appears that triethylamine at a ratio of wires to test compound is 5 to 1 as an additive to a coating may generally improve the coating solution stability at either drying temperatures of 160° F. and 275° F. At a drying temperature of 275° F., the absolute values of Δ(R×H) for morpholine at a ratio of wires to test compound is 10 to 1 were higher than the absolute value of Δ(R×H) of respective comparative samples. However, at a drying temperature of 160° F., the absolute values of Δ(R×H) for morpholine at a ratio of wires to test compound of 10 to 1 were lower than the absolute values of Δ(R×H) of respective comparative samples. At either drying temperatures 160° F. or 275° F., the absolute values of Δ(R×H) for morpholine at a ratio of wires to test compound is 5 to 1 were lower than the absolute values of Δ(R×H) of respective comparative samples. It appears that morpholine at a ratio of wires to test compound of 5 to 1 may improve coating solution stability at either drying temperatures of 160° F. and 275° F. It also appears that morpholine at a ratio of wires to test compound of 10 to 1 may improve coating solution stability at a drying temperature of 160° F. but not at a drying temperature of 275° F.

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the attached claims and all changes that come within the meaning and range of equivalents thereof are intended to be embraced therein.

TABLE III

| | | | | Initial | | |
|---|---|---|---|---|---|---|
| | | Drying | Solution | Surface | | |
| | Test | Temperature | Age | Resistivity | Haze | |
| Sample | Compound | (° F.) | (days) | (ohms/sq) | (percent) | Δ(R × H) |
| Com-6-1 | None | 275 | 0.1 | 101 | 0.86 | — |
| Com-6-2 | None | 275 | 1 | 98 | 0.88 | −0.62 |
| Com-6-3 | None | 275 | 2 | 99 | 0.89 | 1.25 |
| Com-6-4 | None | 275 | 7 | 106 | 0.90 | 8.54 |
| Com-6-5 | None | 275 | 14 | 112 | 0.86 | 9.46 |
| Com-6-6 | None | 160 | 0.1 | 143 | 0.82 | — |
| Com-6-7 | None | 160 | 1 | 105 | 0.86 | −26.96 |
| Com-6-8 | None | 160 | 2 | 131 | 0.87 | −3.29 |
| Com-6-9 | None | 160 | 7 | 171 | 0.87 | 31.51 |
| Com-6-10 | None | 160 | 14 | 196 | 0.86 | 51.30 |
| 6-1 | HEMORP | 275 | 0.1 | 88 | 0.86 | — |
| 6-2 | HEMORP | 275 | 1 | 87 | 0.87 | 0.01 |
| 6-3 | HEMORP | 275 | 2 | 88 | 0.89 | 2.64 |
| 6-4 | HEMORP | 275 | 7 | 88 | 0.90 | 3.52 |
| 6-5 | HEMORP | 275 | 14 | 88 | 0.86 | 0.00 |
| 6-6 | HEMORP | 160 | 0.1 | 92 | 0.85 | — |
| 6-7 | HEMORP | 160 | 1 | 84 | 0.88 | −4.28 |
| 6-8 | HEMORP | 160 | 2 | 93 | 0.91 | 6.43 |
| 6-9 | HEMORP | 160 | 7 | 99 | 0.91 | 11.89 |
| 6-10 | HEMORP | 160 | 14 | 106 | 0.86 | 12.96 |
| 6-11 | MMORP | 275 | 0.1 | 96 | 0.87 | — |
| 6-12 | MMORP | 275 | 1 | 88 | 0.86 | −7.84 |
| 6-13 | MMORP | 275 | 2 | 88 | 0.89 | −5.20 |
| 6-14 | MMORP | 275 | 7 | 93 | 0.90 | 0.18 |
| 6-15 | MMORP | 275 | 14 | 93 | 0.86 | −3.54 |
| 6-16 | MMORP | 160 | 0.1 | 110 | 0.86 | — |
| 6-17 | MMORP | 160 | 1 | 91 | 0.87 | −15.43 |
| 6-18 | MMORP | 160 | 2 | 98 | 0.92 | −4.44 |
| 6-19 | MMORP | 160 | 7 | 101 | 0.89 | −4.71 |
| 6-20 | MMORP | 160 | 14 | 117 | 0.86 | 6.02 |
| 6-21 | BZAM | 275 | 0.1 | 101 | 0.81 | — |
| 6-22 | BZAM | 275 | 1 | 87 | 0.86 | −6.99 |
| 6-23 | BZAM | 275 | 2 | 86 | 0.90 | −4.41 |
| 6-24 | BZAM | 160 | 0.1 | 97 | 0.81 | — |
| 6-25 | BZAM | 160 | 1 | 85 | 0.86 | −5.47 |
| 6-26 | BZAM | 160 | 2 | 94 | 0.93 | 8.85 |

HEMORP = 4-(2-hydroxyethyl)morpholine
MMORP = 4-Methylmorpholine
BZAM = Benzylamine

TABLE IV

| | | Ratio of | | | Initial | | |
|---|---|---|---|---|---|---|---|
| | | Wires to Test | Drying | Solution | Surface | | |
| | Test | Compound | Temperature | Age | Resistivity | Haze | |
| Sample | Compound | (g/g) | (° F.) | (days) | (ohms/sq) | (percent) | Δ(R × H) |
| Com-7-1 | None | None | 275 | 0.1 | 103 | 0.87 | — |
| Com-7-2 | None | None | 275 | 1 | 104 | 0.85 | 1.54 |
| Com-7-3 | None | None | 275 | 2 | 98 | 0.86 | −2.58 |
| Com-7-4 | None | None | 275 | 5 | 111 | 0.86 | 8.60 |
| Com-7-5 | None | None | 275 | 14 | 119 | 0.95 | 26.19 |
| Com-7-6 | None | None | 160 | 0.1 | 112 | 0.86 | — |
| Com-7-7 | None | None | 160 | 1 | 178 | 0.86 | 35.82 |
| Com-7-8 | None | None | 160 | 2 | 173 | 0.86 | 31.52 |
| Com-7-9 | None | None | 160 | 5 | 195 | 0.86 | 50.44 |
| Com-7-10 | None | None | 160 | 14 | 167 | 0.96 | 43.06 |
| 7-1 | TEA | 10/1 | 275 | 0.1 | 85 | 0.88 | — |
| 7-2 | TEA | 10/1 | 275 | 1 | 83 | 0.86 | −3.42 |
| 7-3 | TEA | 10/1 | 275 | 2 | 85 | 0.86 | −1.70 |
| 7-4 | TEA | 10/1 | 275 | 5 | 93 | 0.86 | 5.18 |
| 7-5 | TEA | 10/1 | 275 | 14 | 107 | 1.01 | 33.27 |
| 7-6 | TEA | 10/1 | 160 | 0.1 | 92 | 0.87 | — |
| 7-7 | TEA | 10/1 | 160 | 1 | 101 | 0.86 | 6.82 |
| 7-8 | TEA | 10/1 | 160 | 2 | 99 | 0.86 | 5.10 |
| 7-9 | TEA | 10/1 | 160 | 5 | 104 | 0.96 | 19.80 |
| 7-10 | TEA | 10/1 | 160 | 14 | 115 | 1 | 34.96 |
| 7-11 | TEA | 5/1 | 275 | 0.1 | 87 | 0.84 | — |
| 7-12 | TEA | 5/1 | 275 | 1 | 84 | 0.86 | −0.84 |
| 7-13 | TEA | 5/1 | 275 | 2 | 86 | 0.86 | −12.90 |
| 7-14 | TEA | 5/1 | 275 | 5 | 101 | 0.86 | 0.00 |
| 7-15 | TEA | 5/1 | 160 | 0.1 | 91 | 0.88 | — |
| 7-16 | TEA | 5/1 | 160 | 1 | 93 | 0.86 | −0.10 |
| 7-17 | TEA | 5/1 | 160 | 2 | 95 | 0.86 | 1.62 |
| 7-18 | TEA | 5/1 | 160 | 5 | 99 | 0.86 | 5.06 |
| 7-19 | MORP | 10/1 | 275 | 0.1 | 85 | 0.83 | — |
| 7-20 | MORP | 10/1 | 275 | 1 | 88 | 0.86 | 5.13 |
| 7-21 | MORP | 10/1 | 275 | 2 | 86 | 0.86 | 3.41 |
| 7-22 | MORP | 10/1 | 275 | 5 | 110 | 0.86 | 24.05 |
| 7-23 | MORP | 10/1 | 160 | 0.1 | 90 | 0.85 | — |
| 7-24 | MORP | 10/1 | 160 | 1 | 102 | 0.86 | 11.22 |
| 7-25 | MORP | 10/1 | 160 | 2 | 97 | 0.86 | 6.92 |
| 7-26 | MORP | 10/1 | 160 | 5 | 122 | 0.86 | 28.42 |
| 7-27 | MORP | 5/1 | 275 | 0.1 | 87 | 0.83 | — |
| 7-28 | MORP | 5/1 | 275 | 1 | 85 | 0.86 | 0.89 |
| 7-29 | MORP | 5/1 | 275 | 2 | 85 | 0.86 | 0.89 |
| 7-30 | MORP | 5/1 | 160 | 0.1 | 92 | 0.83 | — |
| 7-31 | MORP | 5/1 | 160 | 1 | 98 | 0.86 | 7.92 |
| 7-32 | MORP | 5/1 | 160 | 2 | 98 | 0.86 | 7.92 |

TEA = Triethylamine
TEA = Triethylamine;
MORP = Morpholine

What is claimed:

1. A transparent conductive article comprising:
a transparent support; and
at least one first layer disposed on the transparent support, the at least one first layer comprising a network of silver nanowires dispersed within at least one polymer binder;
wherein the transparent conductive article comprises one or more additives, the one or more additives comprising at least one amine compound.

2. The transparent conductive article according to claim 1, wherein the at least one first layer comprises the one or more additives.

3. The transparent conductive article according to claim 1, further comprising at least one second layer, wherein the at least one second layer comprises the one or more additives.

4. The transparent conductive article according to claim 3, wherein the at least one second layer is disposed on the at least one first layer.

5. The transparent conductive article according to claim 1, wherein the one or more additives comprising at least one amine compound comprises a mixed amine, the mixed amine comprising a first amine and a second amine selected from the classification group consisting of a primary amine, a secondary amine, and a tertiary amine, the classification group of the first amine being different from the classification group of the second amine.

6. The transparent conductive article according to claim 1, wherein the at least one amine compound is selected from the group consisting of tert-butylamine, benzylamine, piperidine, morpholine, triethylamine, N,N-diisopropylethylamine, N-methyldiethanolamine, 4-(2-hydroxylethyl)morpholine, 4-methylmorpholine, 1-(2-aminoethyl)-piperazine, and N,N-diethylethylenediamine.

7. A transparent conductive article comprising:
a transparent support;
at least one first layer disposed on the transparent support, the at least one first layer comprising a network of silver nanowires dispersed within at least one polymer binder;
wherein the transparent conductive article comprises one or more additives, the one or more additives comprising at least one nitrogen heterocyclic compound selected from the group consisting of 1-decyl-2-methyl-imidazole, pyridine-containing compound, and pyrimidine-containing compound.

8. The transparent conductive article according to claim 7, wherein the at least one first layer comprises the one or more additives.

9. The transparent conductive article according to claim 7, further comprising at least one second layer, wherein the at least one second layer comprises the one or more additives.

10. The transparent conductive article according to claim 9, wherein the at least one second layer is disposed on the at least one first layer.

11. The transparent conductive article according to claim 7, wherein the at least pyridine-containing compound is selected from the group consisting of pyridine, 4-picoline, 2-picoline, 2,6-lutidine, and 4-methylpyrimidine.

12. A method of forming a transparent conductive article comprising:
applying at least one first coating mixture onto a transparent support to form at least one first coated layer, the at least one first coating mixture comprising silver nanowires and at least one polymer binder;
wherein the transparent conductive article comprises one or more additives, the one or more additives comprising at least one amine group or at least one nitrogen heterocyclic compound selected from the group consisting of 1-decyl-2-methyl-imidazole, pyridine-containing compound, and pyrimidine-containing compound.
